(19) United States
(12) Patent Application Publication
(10) Pub. No.: US 2017/0284019 A1
(43) Pub. Date: Oct. 5, 2017

(54) Printed Textile Substrate and Process for Making

(71) Applicant: Milliken & Company, Spartanburg, SC (US)

(72) Inventors: Daniel T. McBride, Chesnee, SC (US); Jenny S. Kimbrell, Spartanburg, SC (US); Simon X. Zhang, Peachtree City, GA (US); Tammy Walker, LaGrange, GA (US)

(73) Assignee: Milliken & Company, Spartanburg, SC (US)

(21) Appl. No.: 15/624,758

(22) Filed: Jun. 16, 2017

Related U.S. Application Data
(62) Division of application No. 14/156,601, filed on Jan. 16, 2014.
(60) Provisional application No. 61/758,304, filed on Jan. 30, 2013.

(51) Int. Cl. D06P 5/12; D06P 3/82; B32B 7/12; D06P 1/00; B32B 5/24; A47G 27/02; D06P 5/30

(52) U.S. Cl. CPC D06P 5/12; A47G 27/02; D06P 3/82; D06P 5/30; D06P 1/0096; B32B 5/245; Y10T 428/18; B32B 2262/0253; B32B 2262/0276; B32B 2262/101; B32B 2266/0278; Y10T 428/23986; B32B 7/12

(57) ABSTRACT

This invention relates to a printed textile substrate, such as a floorcovering article, and a process for making a printed textile substrate. The printed textile substrate contains areas of low viscosity printing ink and high viscosity printing ink. The process for making the textile substrate includes a one pass manufacturing step that results in a textile substrate having areas of low viscosity and high viscosity printing inks.

### CROSS-REFERENCE TO RELATED APPLICATIONS

This application is a divisional of and claims priority to U.S. patent application Ser. No. 14/156,601, entitled “Printed Textile Substrate and Process for Making,” which was filed on Jan. 16, 2014, which claims priority to U.S. Patent Application Ser. No. 61/758,304, entitled “Printed Textile Substrate and Process for Making,” which was filed on Jan. 30, 2013, both of which are entirely incorporated by reference herein.

### TECHNICAL FIELD

This invention relates to a printed textile substrate, such as a floorcovering article, and a process for making a printed textile substrate. The printed textile substrate contains areas of low viscosity printing ink and high viscosity printing ink. The process for making the textile substrate includes a one pass manufacturing step that results in a textile substrate having areas of low viscosity and high viscosity printing inks.

### BACKGROUND

Printed textile substrates, such as floorcovering articles, have been historically dyed and/or printed via several printing processes. In some instances, floorcovering articles are printed using a fluid dyer wherein the article, such as a carpet tile, is submerged within a dye bath to create a solid color shade on the surface of the article. The article may then be subjected to a second pass down the manufacturing range in order to overprint a design on the surface of the article using high viscosity printing inks. This two-step process is time consuming and expensive. In other instances, floorcovering articles are printed with a digital printing machine that uses high viscosity printing inks in order to make a pattern on the surface of the articles. Floorcovering articles, such as carpet tiles, made according to this method lack the ability to provide solid shades and tile to tile edge matching.

In yet another instance, solution dyed yarn is used to manufacture the floorcovering article and then a pattern may be printed on the surface of the article using high viscosity printing inks. This process is undesirable because the base color of the article must be predetermined when the article is manufactured and cannot be changed. The prior art processes utilize high viscosity printing inks due to the nature of the printing machine and need to prevent the printing ink from bleeding when it contacts the surface of the floorcovering article. If the ink is of low viscosity (e.g. less than 15 cp), then the ink will begin to migrate and bleed into areas where coloration is not desired. In order to prevent this from occurring, floorcovering manufacturers utilize printing inks having a sufficiently high viscosity such that the inks are properly placed in a certain location on the surface of the floorcovering article.

Thus, further improvements in the printing of textile substrates, such as floorcovering articles, are needed that can be achieved with one pass down the printing range and that provide excellent solid color shades and patterns. The utilization of several new process steps that will be described herein and the combination of low and high viscosity printing inks results in a printed textile substrate that solves the prior art problems of color separation at the yarn and fiber dimension and provides patterns and designs that were previously unachievable.

### BRIEF SUMMARY

In one aspect, the invention relates to a printed textile substrate comprising a plurality of yarn bundles, wherein at least a portion of the yarn bundles include selective and pre-determined placement of color that results in at least two colors on a single yarn bundle, wherein the bundle is comprised of yarns having differential uptake of dye, and wherein the placement of color occurs after the yarn bundle has been incorporated into the textile substrate.

In another aspect, the invention relates to a printing process comprising selective and pre-determined placement of color that results in at least two colors on a single yarn bundle incorporated into a textile substrate, wherein the bundle is comprised of yarns having differential uptake of dye, and wherein the placement of color occurs after the yarn bundle has been incorporated into the textile substrate.

In yet another aspect, the invention relates to a printed textile substrate comprising a plurality of spatially separated colors on a single fiber type at yarn scale, wherein the textile substrate contains at least two different fiber types, wherein the fiber types exhibit differential uptake of dye, and wherein the plurality of spatially separated colors is provided after the two different fiber types have been incorporated into the textile substrate.

In yet another aspect, the invention relates to a printed floorcovering article comprising a first fiber type and a second fiber type, each of said fiber types having differential uptake of dye and each of said fiber types having a fiber end secured through a tufting hole, wherein at least a portion of the first fiber type is characterized by having multiple colorations at yarn scale on the face of the floorcovering article, and wherein the fiber end of said at least a portion of the first fiber type is free from printing ink.

In yet another aspect, the invention relates to a printed tufted substrate comprising a first fiber type and a second fiber type, each of said fiber types having differential uptake of dye and each of said fiber types having a fiber end secured through a tufting hole, wherein at least a portion of the first fiber type is characterized by having multiple colorations at yarn scale on the face of the printed tufted substrate, and wherein the fiber end of said at least a portion of the first fiber type is free from printing ink.

In yet a further aspect, the invention relates to a printed carpet tile constructed of yarns having differential uptake of dye; and a pile surface, wherein a first area of the pile surface comprises yarn bundles having yarn scale color differentiation and a second area comprising yarn bundles free from yarn scale color differentiation; wherein the polymer composition of the yarn bundles in both areas is the same.

In yet a further aspect, the invention relates to a printed carpet tile constructed of yarns having differential uptake of dye; printed pattern elements in registration; and a pile surface, wherein a first area of the pile surface comprises yarn bundles having yarn scale color differentiation and a second area comprising yarn bundles free from yarn scale color differentiation; wherein the polymer composition of the yarn bundles in both areas is the same.

In yet a further aspect, the invention relates to a printed carpet tile constructed of yarns having differential uptake of dye; printed pattern elements in registration; printed pattern elements that are lighter in shade than background color of the printed carpet tile; a pile surface, wherein a first area of the pile surface comprises yarn bundles having yarn scale color differentiation and a second area comprising yarn bundles free from yarn scale color differentiation; wherein the polymer composition of the yarn bundles in both areas is the same.

In yet a further aspect, the invention relates to a process for manufacturing a printed carpet tile comprising the following steps: providing a tufted carpet tile with two or more yarn types having differential uptake of dye; printing the tufted carpet tile with at least one of an acid dye and a basic dye wherein the dye has a viscosity of less than 15 cp; and steaming the printed carpet tile.

In yet a further aspect, the invention relates to a process for manufacturing a printed carpet tile comprising the following steps: providing a tufted carpet tile with two or more yarn types having differential uptake of dye; printing the tufted carpet tile with acid dye that contains a viscosity modifier; printing the tufted carpet tile with at least one of an acid dye and a basic dye wherein the dye has a viscosity of less than 15 cp; and steaming the printed carpet tile.

In yet a further aspect, the invention relates to a process for manufacturing a printed carpet tile comprising the following steps: providing a tufted carpet tile with two or more yarn types having differential uptake of dye; printing water in a pattern on the surface of the tufted carpet tile; printing the tufted carpet tile with acid dye that contains a viscosity modifier; printing the tufted carpet tile with at least one of an acid dye and a basic dye wherein the dye has a viscosity of less than 15 cp; and steaming the printed carpet tile.

In yet a further aspect, the invention relates to a process for manufacturing a printed carpet tile comprising the following steps: providing a tufted carpet tile with two or more yarn types having differential uptake of dye; pretreating the tufted carpet tile with an aqueous cationic solution; printing water in a pattern on the surface of the tufted carpet tile; printing with the tufted carpet tile with acid dye that contains a viscosity modifier; printing the tufted carpet tile with at least one of an acid dye and a basic dye wherein the dye has a viscosity of less than 15 cp; and steaming the printed carpet tile.

In yet a further aspect, the invention relates to a series of modular carpet tiles comprising a first carpet tile having four edges and a second carpet tile having four edges, wherein each carpet tile is comprised of tufted yarn, and wherein each carpet tile is selectively printed with a composition on at least a portion of the tufted yarn, wherein the composition comprises a printing ink having a viscosity of less than 15 centipoise, and wherein said first carpet tile and said second carpet tile are aligned coextensively along one of the four edges, and wherein the printing ink is visually uniformly distributed from edge alignment of the first and second carpet tiles to edge alignment of the second carpet tile and a third carpet tile.

In yet a further aspect, the invention relates to a printed floorcovering article comprising: (a) a first surface comprising a base substrate having a plurality of individual fibers or yarns attached thereto, wherein said individual fibers or yarns form a pile surface, wherein the individual fibers or yarns are arranged in small groups having varying height such that areas of low pile and areas of high pile are created, wherein said individual fibers or yarns are comprised of at least two polymer types having differential uptake of dye; and (b) wherein said pile surface is printed with a composition comprising a first layer of cationic polymer material and a second layer of printing ink, and wherein the composition is applied substantially uniformly to the areas of low pile and areas of high pile.

In another aspect, the invention relates to a method for forming a printed floorcovering article comprising the sequential steps of: (a) providing a base substrate, (b)attaching individual fibers or yarns to the base substrate to form a pile carpet, (c) attaching a backing layer to the pile carpet, (d) wetting the pile carpet with water, and (e) forming a pattern on the pile carpet with a digital printing apparatus by (i) selectively applying a printing ink to the pile carpet, said printing ink comprising at least one of an acid dye and a basic dye wherein the dye has a viscosity of less than 15 cp.

In another aspect, the invention relates to a printed floorcovering article comprising a base substrate, individual fibers or yarns, and a backing layer, wherein the individual fibers or yarns are mechanically attached to the base substrate to form a pile surface, and wherein said pile surface is selectively digitally printed with a composition to form a pattern on the pile surface, said composition at least one of an acid dye and a basic dye wherein the dye has a viscosity of less than 15 cp, and wherein said printed floorcovering article contains a pattern created by a combination of printed areas and non-printed areas.

In another aspect, the invention relates to a method for imprinting a design on a floorcovering article having a pile surface comprising the following sequential steps: providing a floorcovering article comprising a pile surface; providing a digital printing apparatus; optionally, pre-steaming the substrate; optionally, wetting the pile surface; optionally, using the digital printing apparatus to selectively apply water to at least a portion of the pile surface of the floorcovering article; optionally, using the digital printing apparatus to selectively apply a coating of cationic polymer to at least a portion of the pile surface of the floorcovering article to form areas of cationic polymer-coated pile; using the digital printing apparatus to apply a printing ink to pre-selected areas of the pile surface, wherein the printing ink exhibits a viscosity in the range from about 3 cp to about 20 cp; optionally, using the digital printing apparatus to apply a printing ink to pre-selected areas of the pile surface, wherein the printing ink exhibits a viscosity of greater than about 20; steaming the floorcovering article; washing the floorcovering article; and optionally, applying finishing chemicals to the floorcovering article.

In another aspect, the invention relates to a method for imprinting a design on a floorcovering article having a pile surface comprising the following sequential steps: providing a floorcovering article comprising a pile surface, said pile surface being comprised of a first set of dye receptive fibers or yarns and a second set of non-dye receptive fibers or yarns; using a digital printing apparatus to selectively apply a coating of cationic polymer to the first set of dye receptive fibers or yarns to form areas of cationic polymer-coated fibers or yarns; using a digital printing apparatus to apply a printing ink to the areas of cationic polymer-coated fibers or yarns; and selectively preventing cationic polymer and printing ink from substantially contacting the second set of non-dye receptive fibers or yarns.

In another aspect, the invention relates to a method for imprinting a design on a floorcovering article having a pile surface comprising the following sequential steps: providing a floorcovering article comprising a pile surface, said pile surface being comprised of a first set of individual fibers or yarns and a second set of individual fibers or yarns; using a digital printing apparatus to selectively apply a first coating of cationic polymer to the first set of individual fibers or yarns to form areas of cationic polymer-coated fibers or yarns; using the digital printing apparatus to apply at least one printing ink to the areas of cationic polymer-coated fibers or yarns; using the digital printing apparatus to selectively apply a second coating of cationic polymer to the second set of individual fibers or yarns to form areas of second cationic polymer-coated fibers or yarns; and using the digital printing apparatus to apply at least one printing ink to the second areas of cationic polymer-coated fibers or yarns.

### BRIEF DESCRIPTION OF THE DRAWINGS

FIG. 1A is a flow diagram of one embodiment of a process utilized to manufacture a printed broadloom floorcovering article according to the present invention.

FIG. 1B is a flow diagram of one embodiment of a process utilized to manufacture printed carpet tiles according to the present invention.

FIG. 2 is a schematic representation of a jet dyeing apparatus which may be employed to apply dye to textile substrates according to the present invention.

FIG. 3 is a schematic representation of carpet tiles in relation to the jet dye applicator gun bar section of a jet dyeing apparatus.

FIG. 4 is a grayscale photograph illustrating color application via a fluid dyer apparatus.

FIG. 5 is a grayscale photograph illustrating one embodiment of a printed floorcovering article according to the present invention.

FIG. 6 is a grayscale photograph illustrating one embodiment of a printed floorcovering article according to the present invention.

FIG. 7 is a grayscale photograph illustrating one embodiment of a printed floorcovering article according to the present invention.

FIG. 8 is an exploded schematic view of an exemplary multi-layered carpet construction.

### DETAILED DESCRIPTION

As used herein, “digital printing machine” refers to a computer controlled apparatus that emits printing ink onto the surface of a textile substrate. The textile substrate may include a pile surface.

The term “floorcovering article,” as used herein, is intended to describe a textile substrate which comprises face fibers and which is utilized to cover surfaces on which people are prone to walk. Thus, carpets (broadloom, tile, or otherwise) and floor mats (outdoor, indoor, and the like) are specific types of floorcovering articles.

The term “printing,” as used herein, refers to the process whereby the color of a fiber or yarn is changed, either in whole or in part, by printing ink emitted from a jet dyeing apparatus, or digital printing machine (e.g. the final color of the fiber or yarn is different from the initial color).

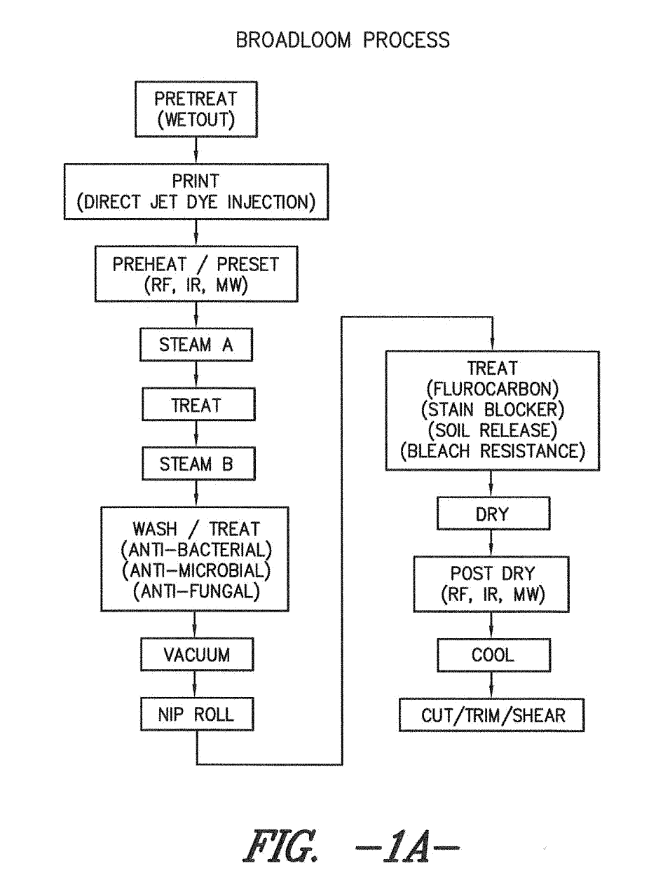

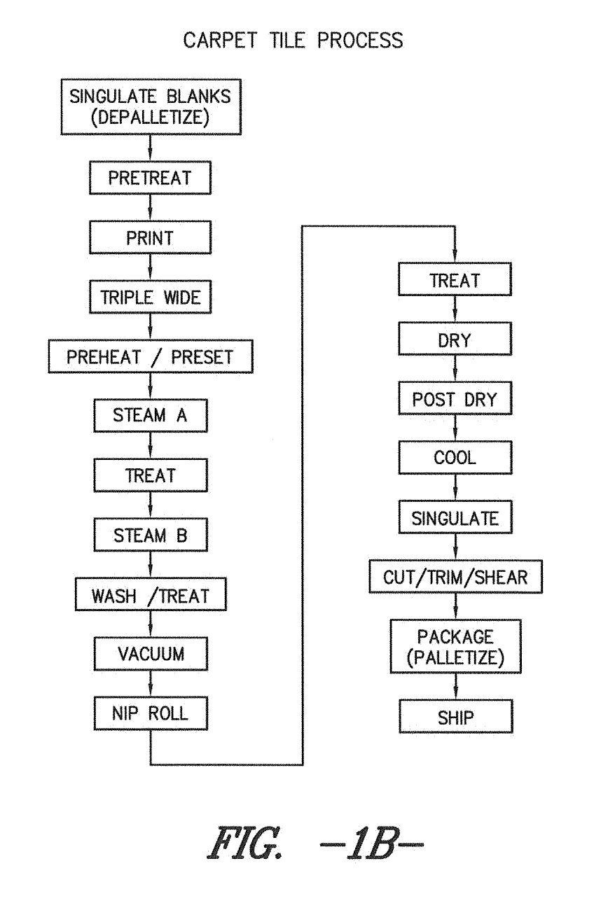

As shown in FIGS. 1A and 1B, digital printing of textile substrates, such as floorcovering articles, typically includes three phases: a pretreatment phase, a printing phase and a post treatment phase. Pretreatment and/or post treatment phases are generally performed to reduce dye bleeding and to achieve better colorfastness.

This invention utilizes a digital printing machine, or jet dyeing apparatus, to print colors, patterns and/or designs on the surface of a textile substrate. The textile substrate may be one that comprises a pile substrate, such as a floorcovering article. In one aspect, the floorcovering article may be a carpet tile.

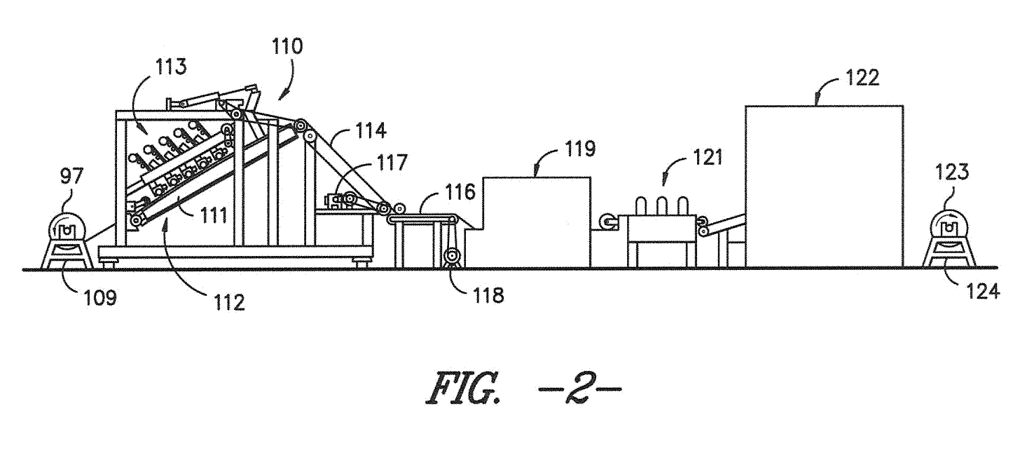

Referring now to FIG. 2, a jet dyeing apparatus is depicted for pattern dyeing a textile substrate, such as a floorcovering article having a pile surface. Supply roll 97 is mounted on a suitable support 109 for supplying a roll of, for example, broadloom carpet. Alternatively, if carpet tiles are being printed, they may be arranged on the conveyor using a vacuum apparatus capable of suction movement of tiles. The floorcovering article is next advanced through dyeing apparatus 110 as follows. The floorcovering article is advanced onto the lower end of inclined conveyor 111 of jet applicator section 112, where the article is printed by a programmed operation of a plurality of jet gun bars, generally indicated at 113, which inject streams of dye onto the face surface (or pile surface) of the floorcovering article during its passage thereunder. The pattern dyed floorcovering article leaving the applicator section is moved by conveyors 114 and 116, driven by motors 117 and 118 to steam chamber 119 where the article is subjected to a steam atmosphere to fix the dyes thereon. The dyed floorcovering article leaving steam chamber 119 is conveyed through a water washer 121 to remove excess unfixed dye from the article. Thereafter, the washed floorcovering article is passed through a hot air dryer 122 to take up roll 123 which is mounted on a suitable support 124. Alternatively, for the printing of carpet tiles, the carpet tiles are removed from the conveyor after leaving hot air dryer 122 and are stacked and prepared for shipment.

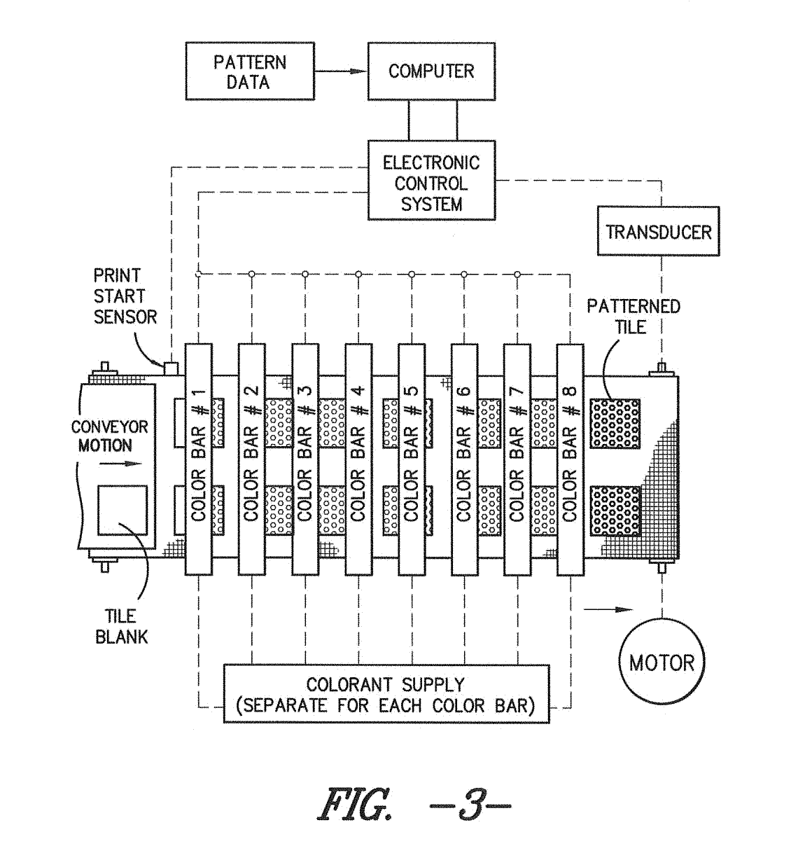

FIG. 3 illustrates in greater detail the process by which carpet tiles are passed under a series of color bars, or gun bars, that emit printing ink on the surface of the tiles thereby providing a printed carpet tile. Printing ink or dyes are contained within each of the color bars until a signal is received from the electronic control system which causes a particular color bar to dispense or drop the ink onto the surface of the floorcovering article. Further details of the jet dyeing apparatus are described, for example, in U.S. Pat. No. 3,939,675 to Klein and U.S. Pat. No. 4,740,214 to McBride et al.

In one aspect, the textile substrate may be pretreated with water which may enhance the color-fixing property. In another aspect, the textile substrate may be pretreated with a cationic material in order to improve colorfastness and reduce bleeding. Cationic materials are materials that have a positive charge. The charge of the cationic material could also be a partial charge. It is believed that the cationic material helps hold the colorant on the surface of the intended zone, thereby reducing any bleeding of the color medium into unintended areas or absorption of the colorant into the textile. Cationic materials that can be used for the present invention include, but are not limited to, polymeric or non-polymeric organic compounds, and metal salts. In one version of the present invention, the cationic compounds are organic cationic materials that include two or more carbon atoms.

Polymeric cationic materials and non-polymeric organic cationic materials of the present invention, including the version of the invention having two or more carbon atoms, can include nitrogen-containing and phosphorus-containing materials. Nitrogen containing cationic materials include, but are not limited to, various primary amines (such as polyvinylamine or polyallyamine), secondary amines, tertiary amines, quaternary amines, and amines converted to cationic amines under acidic conditions. Examples of nitrogen containing cationic polymer materials include homopolymers or copolymers of cationic monomers. Cationic monomers can include diallyldimethylammonium chloride, or methacrylamidopropyltrimethyl ammonium chloride, or the like. Phosphorus containing cationic materials include, but are not limited to, the phosphonium group. Examples of a phosphonium group cationic material include stearyltributyl phosphonium bromide, or the like.

Metal salts that can be used for the cationic material of the present invention include water soluble salts of cations from Group II, Group III, or the Transition Metals of the Periodic Table. Examples include magnesium, calcium, aluminum, zinc, zirconium, and boron. In one embodiment, the salts have an anion of a weak acid, such as acetate forming or the like.

One commercially available cationic polymer is PolyCat M30™, a quaternary stilbene vinyl copolymer available from Peach State Labs.

Pretreatments may be applied in a variety of ways. For example, they may be applied via a bath or pad, via spray application and/or via printing application from the gun bars of the digital printing machine. If the pretreatments are printed from the gun bars, they may be printed in register with the printing ink.

The printing ink used in the invention contains at least one dye. Dyes may be selected from acid dyes, direct dyes, reactive dyes, cationic dyes, disperse dyes, and mixtures thereof. Acid dyes include azo, anthraquinone, triphenyl methane and xanthine types. Direct dyes include azo, stilbene, thiazole, dioxsazine and phthalocyanine types. Reactive dyes include azo, anthraquinone and phthalocyanine types. Cationic dyes include thiazole, methane, cyanine, quinolone, xanthene, azine, and triaryl methine. Disperse dyes include azo, anthraquinone, nitrodiphenylamine, naphthal imide, naphthoquinone imide and methane, triarylmethine and quinoline types.

Specific tile dye selection will depend upon the type of fiber and/or fibers comprising the textile substrate that is being printed. For example, in general, a disperse dye may be used to print polyester or acetate fibers. However, anionic dyes, direct dyes, acid dyes, reactive dyes, and mixtures thereof may be used to print fibers made from wool, silk, polyamide, cotton, and rayon. For materials made from acrylic fiber and cationic dyeable polyester fiber, cationic dyes may be used.

Historically, the use of viscosity modifiers in combination with the printing ink provides the ability to better control the placement of dye on the surface of the article. However, the present invention surprisingly has found that printing inks containing no viscosity modifiers, or very small amounts of viscosity modifiers, actually lead to the creation of patterns and designs heretofore unattainable by prior art printing processes. Furthermore, the combination of printing inks containing little to no viscosity modifiers and certain preferred floorcovering article constructions has provided for an even greater ability to print patterns and designs using a digital printing machine that are novel and unobvious over those of the prior art.

As illustrated in FIG. 3, the printing apparatus contains many color bars. Typically, some will contain dyes that include a viscosity modifier in large amounts, while others, in accordance with the present invention, will contain zero amount, or very small amounts, of viscosity modifiers. Viscosity modifiers typically include any material that, when added to an aqueous medium, increases the viscosity of the aqueous medium.

Suitable viscosity modifiers that may be utilized include known natural water-soluble polymers such as polysaccharides, such as starch substances derived from corn and wheat, gum arabic, locust bean gum, tragacanth gum, guar gum, guar flour, polygalactomannan gum, xanthan, alginates, and a tamarind seed; protein substances such as gelatin and casein; tannin substances; and lignin substances. Examples of the water-soluble polymer further include synthetic polymers such as known polyvinyl alcohol compounds and polyethylene oxide compounds. Mixtures of the aforementioned viscosity modifiers may also be used. Viscosity is often measured in units of centipoise at 25° C., using a Brookfield Viscometer Model LVF, spindle No. 2 at 6 rpm.

Additionally, the printed textile substrate may be exposed to post treatment steps following the step of printing, as illustrated in FIGS. 1A and 1B. For example, chemical treatments such as stain release, stain block, antimicrobial resistance, bleach resistance, and the like, may be added to the printed textile substrate. Mechanical post treatments may include cutting, shearing, and/or napping the surface of the textile substrate.

Floorcovering articles, that may be printing according to the invention described herein include, without limitation, woven carpet, knitted carpet, tufted carpet, graphics tufted carpet, stitched on pile carpet, bonded pile carpet, hooked carpet, knotted pile carpet, and the like. The floorcovering articles may be broadloom carpet or carpet tiles. The floorcovering articles may be of any suitable construction (e.g. hardback, cushion back, etc.). The face may be constructed of any appropriate textile material in yarn or pile form that is suitable for dyeing and patterning, and may have a face height or pile height that is uniform or non-uniform (e.g. may be textured, as found in a multi-level loop pile) created by tufting, needling, flocking, bonding, and the like, or the use of non-woven substrates.

One exemplary multi-layered carpet construction is shown in FIG. 8. In this exemplary construction, the substrate structure 225 is made up of a primary carpet fabric 212 formed from a plurality of pile yarns 214 tufted through a primary backing layer 216 such as a scrim or nonwoven fibrous textile of polyester or polypropylene as will be well known to those skilled in the art. A precoat backing layer 218 of a resilient adhesive such as SBR latex is disposed across the underside of the primary carpet fabric 212 so as to hold the pile yarns 214 in place within the primary backing 216. An adhesive layer 220 such as a hot melt adhesive extends away from the precoat backing layer 218. A layer of stabilizing material 222 such as woven or nonwoven glass is disposed at a position between the adhesive layer 220 and a cushioning layer 224 such as virgin or rebounded polyurethane foam or the like. A secondary backing layer 226 such as a nonwoven blend of polyester and polypropylene fibers is disposed across the underside of the cushioning layer 224.

As will be appreciated, the actual construction of the substrate structure 225 may be subject to a wide range of variations. Accordingly, the multi-layered construction illustrated in FIG. 8 is to be understood as constituting merely an exemplary construction representative of a floorcovering article and that the present invention is equally applicable to any other construction of carpeting and/or other textiles as may be desired. By way of example only, various carpet tile constructions are described in U.S. Pat. Nos. 6,203,881 and 6,468,623.

In the event that the substrate structure is a carpet, the pile yarns 214 may be either spun or filament yarns formed of natural fibers such as wool, cotton, or the like. The pile yarns 214 may also be formed of synthetic materials such as polyamide polymers including nylon 6 or nylon 6,6; polyesters such as PET and PBT; polyolefins such as polyethylene and polypropylene; rayon; and polyvinyl polymers such as polyacrylonitrile. Blends of natural and synthetic fibers such as blends of cotton, wool, polyester and nylon may also be used within the pile yarns 214. In FIG. 8, the pile yarns 214 are illustrated in a loop pile construction. Of course, it is to be understood that other pile constructions as will be known to those of skill in the art including cut pile constructions and the like may likewise be used.

Floorcovering articles may have a fiber face weight in the range from about 1 to about 75 ounces/square yard, or in the range from about 5 to about 60 ounces/square yard, or in the range from about 10 to about 55 ounces/square yard, or in the range from about 20 to about 50 ounces/square yard.

The material comprising the textile substrate, for example, the pile surface of a floorcovering article, may be synthetic fiber, natural fiber, man-made fiber using natural constituents, inorganic fiber, glass fiber, or a blend of any of the foregoing. By way of example only, synthetic fibers may include polyester, acrylic, polyamide, polyolefin, polyaramid, polyurethane, or blends thereof. More specifically, polyester may include polyethylene terephthalate, polytrimethylene terephthalate, polybutylene terephthalate, polylactic acid, or combinations thereof. Polyamide may include nylon 6, nylon 6,6, or combinations thereof. Polyolefin may include polypropylene, polyethylene, or combinations thereof. Polyaramid may include poly-p-phenyleneteraphthalamide (i.e., Kevlar®), poly-m-phenyleneteraphthalamide (i.e., Nomex®), or combinations thereof. Exemplary natural fibers include wool, cotton, linen, ramie, jute, flax, silk, hemp, or blends thereof. Exemplary man-made materials using natural constituents include regenerated cellulose (i.e., rayon), lyocell, or blends thereof.

The textile substrate of the present invention may be formed from staple fiber, filament fiber, slit film fiber, or combinations thereof. The fiber may be exposed to one or more texturing processes. The fiber may then be spun or otherwise combined into yarns, for example, by ring spinning, open-end spinning, air jet spinning, vortex spinning, or combinations thereof. Accordingly, the textile substrate will generally be comprised of interlaced fibers, interlaced yarns, loops, or combinations thereof.

The textile substrate may be comprised of fibers or yarns of any size, including microdenier fibers or yarns (fibers or yarns having less than one denier per filament). The fibers or yarns may have deniers that range from less than about 0.1 denier per filament to about 2000 denier per filament or, more preferably, from less than about 1 denier per filament to about 500 denier per filament.

Furthermore, the textile substrate may be partially or wholly comprised of multi-component or bi-component fibers or yarns in various configurations such as, for example, islands-in-the-sea, core and sheath, side-by-side, or pie configurations. Depending on the configuration of the bi-component or multi-component fibers or yarns, the fibers or yarns may be splittable along their length by chemical or mechanical action.

Additionally, the fibers comprising the textile substrate may include additives coextruded therein, may be precoated with any number of different materials, including those listed in greater detail below, and/or may be dyed or colored to provide other aesthetic features for the end user with any type of colorant, such as, for example, poly(oxyalkylenated) colorants, as well as pigments, dyes, tints, and the like. Other additives may also be present on and/or within the target fiber or yarn, including antistatic agents, brightening compounds, nucleating agents, antioxidants, UV stabilizers, fillers, permanent press finishes, softeners, lubricants, curing accelerators, and the like.

The printing process of the present invention uses a jet dyeing machine, or a digital printing machine, to place printing ink on the surface of the textile substrate (such as a carpet tile) in predetermined locations. One suitable and commercially available digital printing machine is the Millitron® digital printing machine, available from Milliken & Company of Spartanburg, S.C. The Millitron® machine uses an array of jets with continuous streams of dye liquor that can be deflected by a controlled air jet. The array of jets, or gun bars, is typically stationary. Another suitable and commercially available digital printing machine is the Chromojet® carpet printing machine, available from Zimmer Machinery Corporation of Spartanburg, S.C. In one aspect, a tufted carpet made according to the processes disclosed in U.S. Pat. No. 7,678,159 and U.S. Pat. No. 7,846,214, both to Weiner, may be printed with a jet dyeing apparatus as described and exemplified herein.

In one aspect, a basic dye is applied first to the surface of the textile substrate, following by the application of an acid dye on top of the basic dye in order to create a desired pattern. A floorcovering article prepared with a graphics tufting machine and dyed using a fluid dyer cannot achieve two or more colors in a predetermined way that cross over the thread line (in the same tuft row). This combination cannot create patterns that create a diagonal line or a curved line. Pre-tufting solution dyed yarns is the only alternative way to achieve such patterns.

With respect to viscosity of basic dyes and acid dyes that may be utilized for printing the textile substrate, there are several variations that may be contemplated. For instance, acid and basic dyes may be combined together and dispersed from a single gun bar. In this instance, the viscosity of the combined dye mixture is in the range from about 3 cp to about 20 cp, as described previously herein.

However, if acid dyes and basic dyes are applied separately to a textile substrate via more than one gun bar, then the viscosity for at least one of the dyes may change. For example, when printing with a basic dye followed by an acid dye, the viscosity of the basic dye may be in the range from about 3 cp to about 20 cp, as described previously herein, while the viscosity of the acid dye may be greater than 20 cp, and may be in the range from about 20 cp to about 150 cp or in the range from 30 cp to about 120 cp. Such combinations of dyes and viscosities provide visibly distinct and desirable color separation between different fiber types and textile substrate constructions.

The present invention allows for the selective and pre-determined placement of color that results in at least two colors in or on a yarn bundle, wherein the bundle is comprised of yarns having differential uptake of dye. One example of yarns having a differential uptake of dye includes a yarn bundle comprising a first yarn or fiber having a chemical attraction to a first dye type and a second yarn or fiber having a chemical attraction to a second, different dye type. This is different from space dyed yarns, wherein space dyed yarns are dyed prior to their incorporation into a textile substrate.

Thus, the present invention discloses the ability to have more than one, spatially separated (not a heather), colors on a single fiber (or polymer) type at yarn scale (or on a single yarn or on a single yarn type) after incorporation of the fiber(s) or yarn(s) into a textile substrate (e.g. after tufting), wherein the textile substrate contains at least two different polymer (e.g. yarn or fiber) types, and wherein the at least two different polymer types exhibit differential uptake of dye. In one aspect, a yarn bundle having yarn type A and yarn type B is presented. Yarn type A must have multiple colors on a single fiber. The colors are applied after it is incorporated into a textile substrate. The colors may be in register at yarn scale. In the case of a floorcovering article, wherein the article is a carpet tile, the colors may be in register from tile to tile. Accordingly, a predetermined pattern can be manipulated at an individual fiber end.

In yet another aspect, the present invention includes a carpet tile or floorcovering article containing at least two fiber types, Fiber A and Fiber B. Fibers A and B are secured to a substrate through a tuft hole. Fibers A and B may be secured to a substrate through the same tuft hole or through different tuft holes or both. This arrangement creates a pile surface on the face of the carpet tile or floorcovering article. Fiber A and fiber B exhibit differential uptake of dye. Further, Fiber A exhibits multiple colorations at yarn scale on the face of the tile. Fiber A also exhibits no change in color on the back side of the tuft hole through which the fiber is secured (on the side opposite the pile surface of the floorcovering article, e.g. carpet tile).

In another aspect, a tufted substrate containing at least two polymer fiber types having differential uptake of dye is disclosed, wherein at least one of the fiber types has multiple colorations at yarn scale on the face of the tufted substrate.

### EXAMPLES

Unless otherwise indicated, viscosity was measured using a Brookfield LVT Viscometer available from Brookfield Laboratories, Stoughton, Mass., operating at 60 rpm using a #3 spindle.

### Example 1

A printed floorcovering article was prepared as follows:

A base substrate was constructed of 35 oz/yd tufted nylon 6,6 loop carpet containing an acid dyeable yarn component (yarn dyed with acid dyes) and a basic dyeable yarn component (yarn dyed with basic dyes), tufted through a primary backing from Mattex USA LLC. The acid dyeable yarn was 55% of the tufted face weight and the basic dyeable yarn was 45% of the tufted face weight in a checkerboard pattern. The acid dyeable yarn was a 2 ply, 3 ends per tufting needle of a deep dye (type 1410) and a regular dye (type 1360), 21 denier per filament fiber, both available from Solutia. The basic dyeable yarn was a 2 ply, 2 ends per tufting needle of a bright cationic (type 1730), 25.4 denier per filament fiber available from Solutia. All yarn was in an undyed state. However, it should be noted that solution dyed yarn may optionally be used.

The base substrate was first run through a bath of 65° C. water and extracted, leaving 40% wet pick-up, based on face fiber total weight (WPU). An aqueous dye solution containing both acid and basic dyes was prepared as shown in Table A.

TABLE A
Aqueous Dye Solution

| | Amount | |
|---|---|---|
| | (grams/ | |
| Ingredient | liter) | Manufacturer/Supplier |
| Acid dye, FOUR ACID | 2.2176 | Fibro Chem Ind., Dalton GA |
| ORANGE 3G 33% | | |
| Acid dye, FOUR ACID RED | 0.837 | Fibro Chem Ind., Dalton GA |
| 2B 50% LIQ | | |
| Acid dye, Tectilon Blue M-AR | 0.8192 | Huntsman, Charlotte NC |
| Liq | | |
| Basic dye, Sevron Yellow | 0.0905 | Fibro Chem Ind., Dalton Ga. |
| 3RL | | |
| Basic dye, Sevron Red YCN | 0.0036 | Dye Systems, Dalton GA |
| PWD | | |
| Basic Dye, Sevron Blue NCN | 0.133 | Dye Systems, Dalton GA |
| Liq | | |
| Chemical, Acetic Acid | 0.005 | Harcros Chemicals, Dalton |
| | | GA |
| Chemical, SA 30 | 0.0336 | Phoenix Chemicals, |
| | | Somerville NJ |
| Chemical, Antiprecipitant 60-N | 0.04 | Lenmar Chemical, Dalton GA |

The viscosity of the dye solution was 1 centipoise (cp). The dye solution was uniformly applied at 55° C. and at 350% WPU over the entire substrate, by means of a QCC Fluidyer, available from Kusters Zima of Spartanburg, S.C. USA. The base substrate was then atmospherically steamed, washed and dried by methods known to those skilled in the art.

Because of the arrangement of the acid dyeable yarn and the basic dyeable yarns and the use of both acid and basic dyes, the floorcovering article exhibited a differentiated checkerboard pattern of two colorations: (1) the acid dyeable yarn was a chocolate brown color and (2) the basic dyeable yarn was a light green color. A grayscale photograph of the printed floorcovering article is shown in FIG. 4. The acid dyeable yarns 410 were chocolate brown in color, while the basic dyeable yarns 420 were a light green color.

### Examples 2-4

Examples 2-4 used the same base material as was used in Example 1. Each base material was printed using a Millitron® digital printing machine (available from Milliken & Company, Spartanburg, S.C.). The Millitron® machine was preloaded with 10 aqueous dye solutions as shown in Table B.

TABLE B
Millitron ® Color Bar Loadings

| | Millitron ® Color Bar Number | | | | | | | | | |
|---|---|---|---|---|---|---|---|---|---|---|
| | 1 | 2 | 3 | 4 | 5 | 6 | 7 | 8 | 9 | 10 |
| | Amount | | | | | | | | | |
| Product | (grams/liter) | | | | | | | | | |
| Telon Red | 0.33 | 0 | 0 | 0 | 0 | 0.66 | 2.77 | 0.035 | 0.039 | 0.012 |
| BRL Micro^{a} | | | | | | | | | | |
| Telon Blue | 0 | 0 | 0 | 0 | 0 | 0 | 2.24 | 0.1284 | 0.103 | 0.035 |
| BRL Micro^{a} | | | | | | | | | | |
| Telon Yellow | 0.6825 | 0 | 0 | 0 | 0 | 1.365 | 6.824 | 0.1308 | 0.288 | 0.0896 |
| 4R^{a} | | | | | | | | | | |
| Telon Black | 3.6 | 0 | 0 | 0 | 0 | 7.2 | 0 | 0 | 0 | 0 |
| AMF^{a} | | | | | | | | | | |
| Erionyl Black | 0 | 0.1747 | 0.1747 | 0 | 0 | 0 | 0 | 0 | 0 | 0 |
| MR^{b} | | | | | | | | | | |
| Erionyl Yellow | 0 | 0.0599 | 0.0599 | 0 | 0 | 0 | 0 | 0 | 0 | 0 |
| MR^{b} | | | | | | | | | | |
| Isolan | 0 | 0.007 | 0.007 | 0 | 0 | 0 | 0 | 0 | 0 | 0 |
| Bordeaux R^{a} | | | | | | | | | | |
| Astrazon | 0 | 0 | 0 | 0 | 0.026 | 0 | 0 | 0 | 0 | 0 |
| Yellow 7GLL^{a} | | | | | | | | | | |
| Severon Red | 0 | 0 | 0 | 0 | 0.038 | 0 | 0 | 0 | 0 | 0 |
| YCN PWD^{c} | | | | | | | | | | |
| Severon Blue | 0 | 0 | 0 | 0 | 4.5 | 0 | 0 | 0 | 0 | 0 |
| NCN Liq^{c} | | | | | | | | | | |
| Acetic Acid^{d} | 0.5 | 0.5 | 0.5 | 0 | 0.5 | 0.5 | 0.5 | 0.5 | 0.5 | 0.5 |
| S.A. 30^{e} | 3.5 | 3.5 | 3.5 | 0 | 3.5 | 3.5 | 3.5 | 3.5 | 3.5 | 3.5 |
| Anti- | 4 | 4 | 4 | 0 | 4 | 4 | 4 | 4 | 4 | 4 |
| precipatant | | | | | | | | | | |
| 60N^{f} | | | | | | | | | | |
| FT24^{g} | 3 | 3 | 3 | 0 | 3 | 3 | 3 | 3 | 3 | 3 |
| Poly OX | 0 | 0 | 0 | 0 | 2.5 | 2.5 | 2.5 | 2.5 | 2.5 | 2.5 |
| N12K^{h} | | | | | | | | | | |
| Noxaxan 80, | 3.75 | 3.75 | 3.75 | 0 | 0 | 0 | 0 | 0 | 0 | 0 |
| xanthan gumⁱ | | | | | | | | | | |

^{a}available from Dyestar, Charlotte, NC.
^{b}available from Huntsman, Charlotte, NC.
^{c}available from Dye Systems, Dalton, GA.
^{d}available from Harcros Chemicals, Dalton GA.
^{e}available from Phoenix Chemicals, Somerville, NJ.
^{f}available from Lenmar Chemical, Dalton, GA.
^{g}available from Milliken & Company, Spartanburg, SC.
^{h}available from Dow, Midland, MI.
ⁱavailable from ADM, Decatur, IL.

### Example 2

All colors were printed in predetermined areas and all the dye solutions were at a viscosity of 500 centipoise (cp). The base substrate was pretreated at 20% wet pick-up (based on substrate face fiber weight) with an aqueous solution of Polycat M-30, available from Peach State Labs Inc. of Rome, Ga. All the dye solutions were acid dyes only and were printed at 200% WPU.

The printing floorcovering article did not exhibit any color separation or differentiation. Both the acid dyeable and the basic dyeable yarns were the same color within each of the preselected print areas.

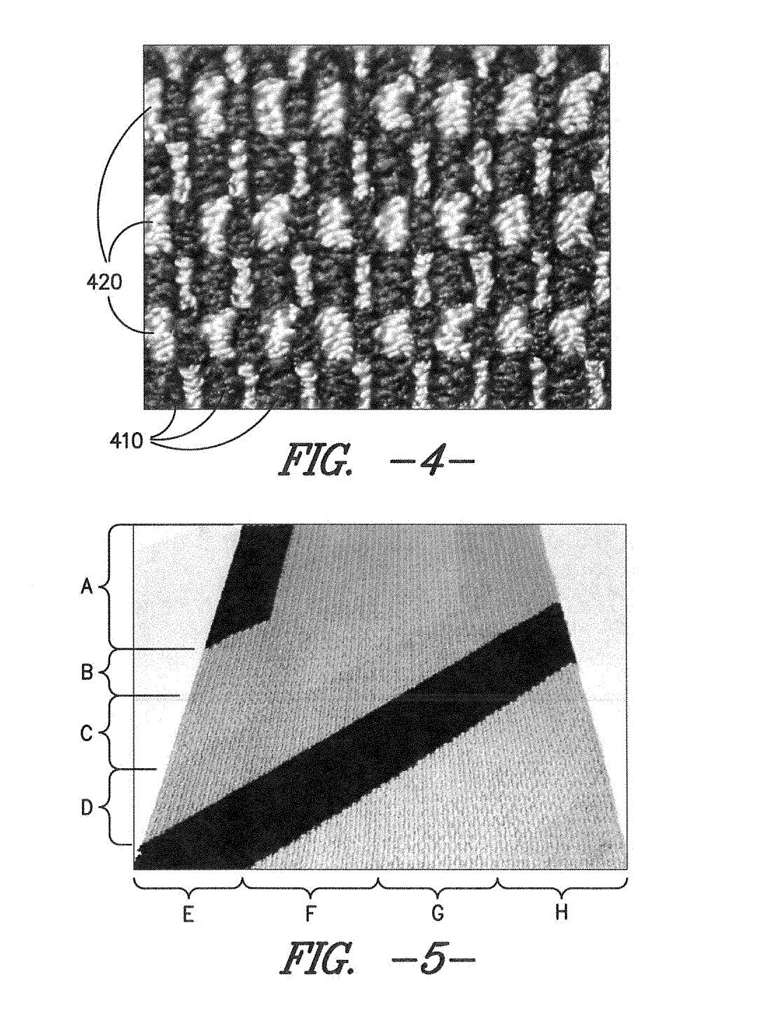

A grayscale photograph of the printed floorcovering article is shown in FIG. 5. As shown in FIG. 5, color bands A through H were created. Each of the color bands was the result of printing from a specific color bar or combination of color bars. Thus, using Table B as a guide, Band “A” was Color Bar 1, Band “B” was Color Bar 2, Band “C” was Color Bar 3, Band “D” was a 50:50 blend of Color Bars 2 and 3, Band “E” was Color Bar 1, Band “F” was Color Bar 2, Band “G” was Color Bar 3, and Band “H” was a 50:50 blend of Color Bars 2 and 3.

### Example 3

Example 2 was repeated, except all colors were printed using dye solutions at 4 cp. PolyOx N12K, supplied by Dow Chemical of Midland, Mich. was used as the viscosity modifier. Polycat M-30 was applied as a pretreatment to the base substrate at 20% WPU. Then, Color Bar 5 was printed at 100% WPU over the entirety of the base substrate, dyeing the basic dyeable yarns a blue shade. Next, acid dye solutions of 4 cp were printed in predetermined areas.

The result was a printed floorcovering article similar to that obtained in Example 2, but both the acid dyeable and the basic dyeable yarns were differentiated, or separated in color. In other words, the basic dyeable yarn was a blue shade and various desired colors of the acid dyeable yarns were realized.

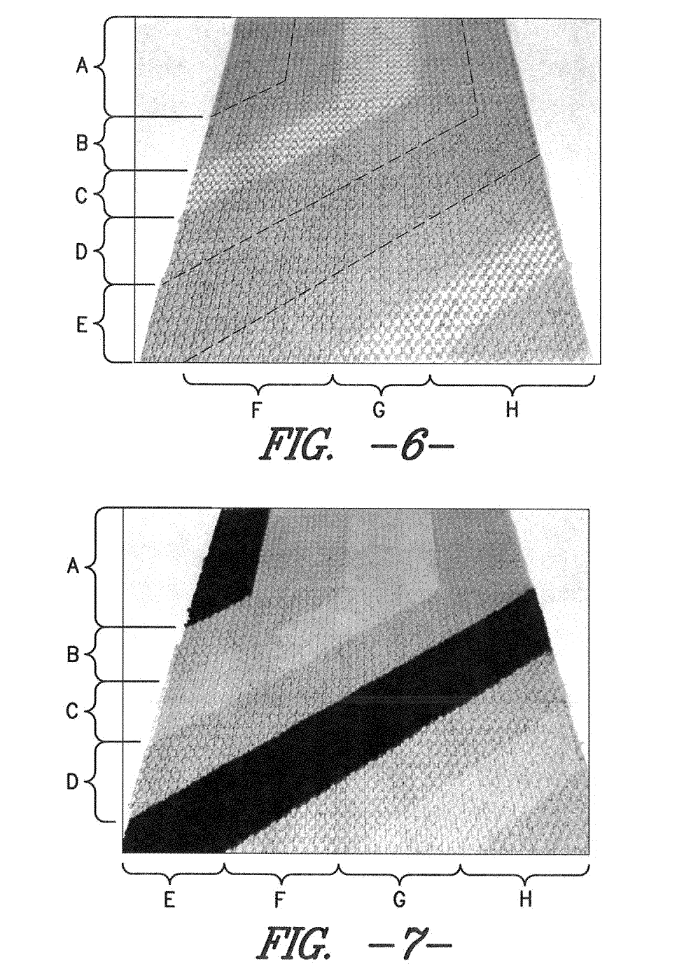

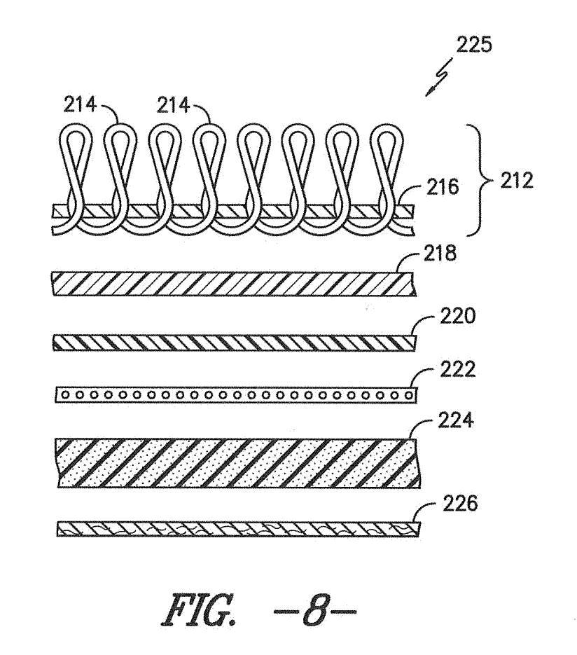

A grayscale photograph of the printed floorcovering article is shown in FIG. 6. As shown in FIG. 6, color bands A through H were created. Each of the color bands was the result of printing from a specific color bar or combination of color bars. Thus, using Table B as a guide, Band “A” was Color Bar 9, Band “B” was Color Bar 8, Band “C” was Color Bar 10, Band “D” was Color Bar 8, Band “E” was Color Bar 9, Band “F” was Color Bar 8, Band “G” was Color Bar 10 and Band “H” was Color Bar 8.

### Example 4

Example 2 was repeated, except both high viscosity (500 cp) and low viscosity (4 cp) dye solutions were printed on the same base substrate. In the areas of low viscosity, the basic dye solution was applied first and the acid dye solutions were applied second.

The result was that in the areas of high viscosity (500 cp), no differentiation or separation of color occurred. Only the acid dye color was realized (i.e. visible). However, in the areas of low viscosity, color separation was achieved. The basic dye fiber was the blue shade of Color Bar 5, and the acid dye fiber was realized in the predetermined pattern areas.

A grayscale photograph of the printed floorcovering article is shown in FIG. 6. As shown in FIG. 6, color bands A through H were created. Each of the color bands was the result of printing from a specific color bar or combination of color bars. Thus, using Table B as a guide, Band “A” was Color Bar 1, Band “B” was Color Bar 5 first and Color Bar 8 second, Band “C” was Color Bar 3, Band “D” was Color Bar 5 first and Color Bar 9 second, Band “E” was Color Bar 1, Band “F” was Color Bar 5 first and Color Bar 8 second, Band “G” was Color Bar 3 and Band “H” was Color Bar 5 first and Color Bar 9 second.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. A printing process comprising selective and pre-determined placement of color that results in at least two colors on a single yarn bundle incorporated into a textile substrate, wherein the bundle is comprised of yarns having differential uptake of dye, and wherein the placement of color occurs after the yarn bundle has been incorporated into the textile substrate.

2. A process for manufacturing a printed carpet tile comprising the following steps:
a. Providing a tufted carpet tile with two or more yarn types having differential uptake of dye;
b. Printing the tufted carpet tile with at least one of an acid dye and a basic dye wherein the dye has a viscosity of less than 15 cp; and
c. Steaming the printed carpet tile.

3. A process for manufacturing a printed carpet tile comprising the following steps:
a. Providing a tufted carpet tile with two or more yarn types having differential uptake of dye;
b. Printing the tufted carpet tile with acid dye that contains a viscosity modifier;
c. Printing the tufted carpet tile with at least one of an acid dye and a basic dye wherein the dye has a viscosity of less than 15 cp; and
d. Steaming the printed carpet tile.

4. A process for manufacturing a printed carpet tile comprising the following steps:
a. Providing a tufted carpet tile with two or more yarn types having differential uptake of dye;
b. Printing water in a pattern on the surface of the tufted carpet tile;
c. Printing the tufted carpet tile with acid dye that contains a viscosity modifier;
d. Printing the tufted carpet tile with at least one of an acid dye and a basic dye wherein the dye has a viscosity of less than 15 cp; and
e. Steaming the printed carpet tile.

5. A process for manufacturing a printed carpet tile comprising the following steps:
a. Providing a tufted carpet tile with two or more yarn types having differential uptake of dye;
b. Pretreating the tufted carpet tile with an aqueous cationic solution;
c. Printing water in a pattern on the surface of the tufted carpet tile;
d. Printing with the tufted carpet tile with acid dye that contains a viscosity modifier;
e. Printing the tufted carpet tile with at least one of an acid dye and a basic dye wherein the dye has a viscosity of less than 15 cp; and
f. Steaming the printed carpet tile.

6. A series of modular carpet tiles comprising a first carpet tile having four edges and a second carpet tile having four edges, wherein each carpet tile is comprised of tufted yarn, and wherein each carpet tile is selectively printed with a composition on at least a portion of the tufted yarn, wherein the composition comprises a printing ink having a viscosity of less than 15 centipoise, and wherein said first carpet tile and said second carpet tile are aligned coextensively along one of the four edges, and wherein the printing ink is visually uniformly distributed from edge alignment of the first and second carpet tiles to edge alignment of the second carpet tile and a third carpet tile.

7. A method for forming a printed floorcovering article comprising the sequential steps of:
(a) providing a base substrate,
(b) attaching individual fibers or yarns to the base substrate to form a pile carpet,
(c) attaching a backing layer to the pile carpet,
(d) wetting the pile carpet with water, and
(e) forming a pattern on the pile carpet with a digital printing apparatus by (i) selectively applying a printing ink to the pile carpet, said printing ink comprising at least one of an acid dye and a basic dye wherein the dye has a viscosity of less than 15 cp.

8. A method for imprinting a design on a floorcovering article having a pile surface comprising the following sequential steps:
(a) providing a floorcovering article comprising a pile surface;
(b) providing a digital printing apparatus;
(c) optionally, pre-steaming the substrate;
(d) optionally, wetting the pile surface;
(e) optionally, using the digital printing apparatus to selectively apply water to at least a portion of the pile surface of the floorcovering article;
(f) optionally, using the digital printing apparatus to selectively apply a coating of cationic polymer to at least a portion of the pile surface of the floorcovering article to form areas of cationic polymer-coated pile;
(g) using the digital printing apparatus to apply a printing ink to pre-selected areas of the pile surface, wherein the printing ink exhibits a viscosity in the range from about 3 cp to about 20 cp;
(h) optionally, using the digital printing apparatus to apply a printing ink to pre-selected areas of the pile surface, wherein the printing ink exhibits a viscosity of greater than about 20;
(i) steaming the floorcovering article;
(j) washing the floorcovering article; and
(k) optionally, applying finishing chemicals to the floorcovering article.

9. A method for imprinting a design on a floorcovering article having a pile surface comprising the following sequential steps:
(a) providing a floorcovering article comprising a pile surface, said pile surface being comprised of a first set of dye receptive fibers or yarns and a second set of non-dye receptive fibers or yarns;
(b) using a digital printing apparatus to selectively apply a coating of cationic polymer to the first set of dye receptive fibers or yarns to form areas of cationic polymer-coated fibers or yarns;
(c) using a digital printing apparatus to apply a printing ink to the areas of cationic polymer-coated fibers or yarns; and
(d) selectively preventing cationic polymer and printing ink from substantially contacting the second set of non-dye receptive fibers or yarns.

10. A method for imprinting a design on a floorcovering article having a pile surface comprising the following sequential steps:
(a) providing a floorcovering article comprising a pile surface, said pile surface being comprised of a first set of individual fibers or yarns and a second set of individual fibers or yarns;
(b) using a digital printing apparatus to selectively apply a first coating of cationic polymer to the first set of individual fibers or yarns to form areas of cationic polymer-coated fibers or yarns;
(c) using the digital printing apparatus to apply at least one printing ink to the areas of cationic polymer-coated fibers or yarns;
(d) using the digital printing apparatus to selectively apply a second coating of cationic polymer to the second set of individual fibers or yarns to form areas of second cationic polymer-coated fibers or yarns; and
(e) using the digital printing apparatus to apply at least one printing ink to the second areas of cationic polymer-coated fibers or yarns.
